(19) United States
(12) Patent Application Publication
(10) Pub. No.: US 2005/0179668 A1
(43) Pub. Date: Aug. 18, 2005

(54) Electronic device with a flat panel display and touch buttons/pads outside the display area

(75) Inventor: Martin J Edwards, Crawley (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/511,291

(22) PCT Filed: Apr. 1, 2003
(86) PCT No.: PCT/IB03/01398

(30) Foreign Application Priority Data
Apr. 16, 2002 (GB) 0208655.1

(51) Int. Cl. G09G 5/00

(52) U.S. Cl. 345/173

(57) ABSTRACT

An electronic device has a display panel (10), for example an active matrix liquid crystal display device, and includes touch input means which are operable by a user to perform input functions and which comprise touch elements (15, 18) in the form of button, pads or the like, spaced from the display panel and carried on a housing or frame (20) containing the display panel, and a sensing circuit (35) connected to the touch elements which is carried on a substrate (30) of the display panel together with a drive circuit (33, 34) of the display panel. Provision of the sensing circuit on the display panel substrate leads to compactness and reduced manufacturing costs while the separation of the touch elements from the display panel offers considerable flexibility in, for example, the arrangement of the touch elements and without risk of the display panel being contaminated or damaged.

The present invention relates to display panels with user input functions and to electronic devices using such.

It is well known to provide a flat panel display device, for example a liquid crystal display device, with control or data input facility through which a user can perform various operations such as data input or control functions by using a finger, pen or stylus. Such touch input and interactivity are important features, particularly for handheld and mobile display devices. A typical example of this kind of device is a palmtop computer device with PIM (Personal Information Management) software applications, such as that described, for example, in U.S. Pat. No. 5,900,875. In this kind of device it is possible for a user to enter data or perform control functions by means of a stylus interacting with a touch sensor overlying the display screen of the device.

A commonly used form of sensor for this purpose comprises a transparent resistive film provided as an overlay for the display screen. In response to the resistive film being touched by the stylus, a signal indicative of the position of the touch on the film, and thus the corresponding position on the display screen, is obtained through sensing circuitry connected to the resistive film. Information can be entered into the computer device by writing with the stylus over the display screen. In addition, control functions can be selected by arranging for the display screen to display in a dedicated area control buttons or the like representing the control functions and the user activating a particular button function by touching the resistive film at the corresponding position. A problem with the use of resistive sensing films in this way is that they can reduce the brightness of the display output or otherwise impair the quality of the display produced by the display screen, for example through reflection effects at the surface. Moreover, the film may easily become dirty through touching, particularly when using a finger, and the action of touching the film can subject the display panel to mechanical stress which may possibly lead to damage.

The computer device described in U.S. Pat. No. 5,900,875 further includes a series of mechanical button switches located in the housing of the device away from the display screen which are operable to control certain specific functions such as main power on/off, software application selection, and scrolling information displayed on the display screen up and down. These buttons would normally be implemented in the form of miniature electro-mechanical switches carried on a circuit board, for example the main processor circuit board, located within the device's housing and connected to appropriate control circuitry similarly carried on the circuit board. The necessary sensing circuitry for detecting touch inputs to the resistive overlay film may also be carried on the same circuit board or a separate circuit board and connected to the resistive film through, for example, a foil type of connection. Although the separation of the set of electromechanical switches from the display screen means that their use will not lead to dirtying of, or damage to, the display screen, a significant amount of space needs to be devoted to the provision of electro-mechanical switches and a circuit board with sensing circuitry for such purposes. Since it is desirable for such a mobile computing device, or at least its housing, to be as compact as possible this can be a disadvantage.

It is an object of the present invention to provide an improved flat panel display device with user input functions.

According to the present invention, there is provided an electronic device comprising a display panel having at least one substrate on which are formed display pixels defining a display area in which information is displayed, the device further including a drive circuit for driving the pixels, and touch input means operable by a user to perform input functions, the touch input means comprising touch elements which are spaced from the substrate of the display panel and a sensing circuit connected to the touch elements for sensing touching of the touch elements by a user, wherein the drive circuit for the display pixels and the sensing circuit of the touch input means are both carried on the substrate of the display panel.

The invention offers significant advantages over known devices, which can lead to a much more compact arrangement and to reduced manufacturing costs. As the touch elements of the touch sensing means are separate from the display panel, there is no risk of the display area being contaminated with dirt or grease from a user's finger or being damaged by mechanical stress in normal usage. Unlike the kind of arrangement in U.S. Pat. No. 5,900,875, where input buttons are provided separate from the display panel, however, the touch input means is not completely separate from the display panel with the associated sensing circuits being provided independently and on a separate carrier.

The invention allows considerable flexibility in the design, lay-out and positioning of the touch elements (buttons, pads or other like structures with which a user interacts), without changes to the circuitry carried on the display panel substrate being necessary.

Providing the sensing circuitry of the touch input means and the display pixel drive circuitry on the same substrate of the display panel is of considerable benefit to saving space, and, in the case where the input function concerns the nature of the display output provided by the display panel, can greatly simplify interconnection aspects by enabling the sensing circuitry to communicate in a more direct manner with the pixel drive circuitry.

In commonly-used flat display panels, such as active matrix liquid crystal display (AMLCD) panels and active matrix electroluminescent (AMEL) display panels, drive circuits are typically provided in the form of ICs mounted on one substrate of the panel, there being normally two substrates in an AMLCD device and one in an AMEL device. It is becoming increasingly common, particularly in active matrix display devices using polysilicon technology to integrate drive circuits fully on the active substrate carrying the active matrix circuits comprising pixel electrodes, pixel TFTs and sets of address conductors formed from deposited thin film layers, by fabricating them in similar manner and at the same time as the active matrix circuitry from common deposited thin film layers. In a preferred embodiment of the invention, therefore, the pixel drive circuit and the sensing circuit comprise thin film circuits integrated on the substrate. Accordingly, the sensing circuit is provided at minimal additional cost. Moreover, such circuitry can be readily accommodated at the peripheral region of the substrate enabling a highly compact arrangement to be obtained.

Various different kinds of touch input sensing technology may be employed. The term touch input sensing is used herein to signify both physical contact sensing and proximity sensing and the term should be construed accordingly. Preferably, capacitive or resistive sensing techniques are used, as known in the art of touch sensing. Alternatively, other known techniques such as electric field sensing, optical sensing may be used.

Embodiments of electronic devices with display panels and user input functions in accordance with the present invention will now be described, by way of example, with reference to the accompanying drawings, in which:—

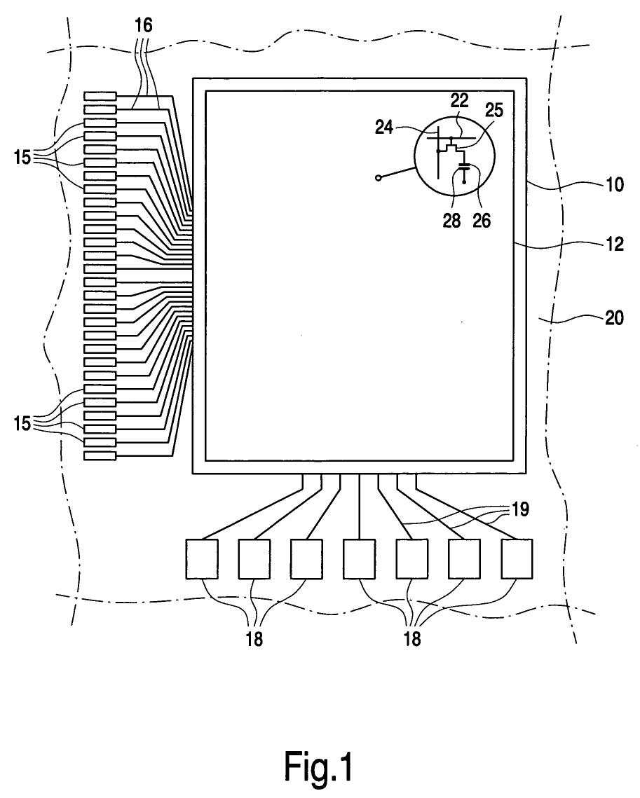

FIG. 1 shows schematically certain features in part of an embodiment of electronic device according to the invention;

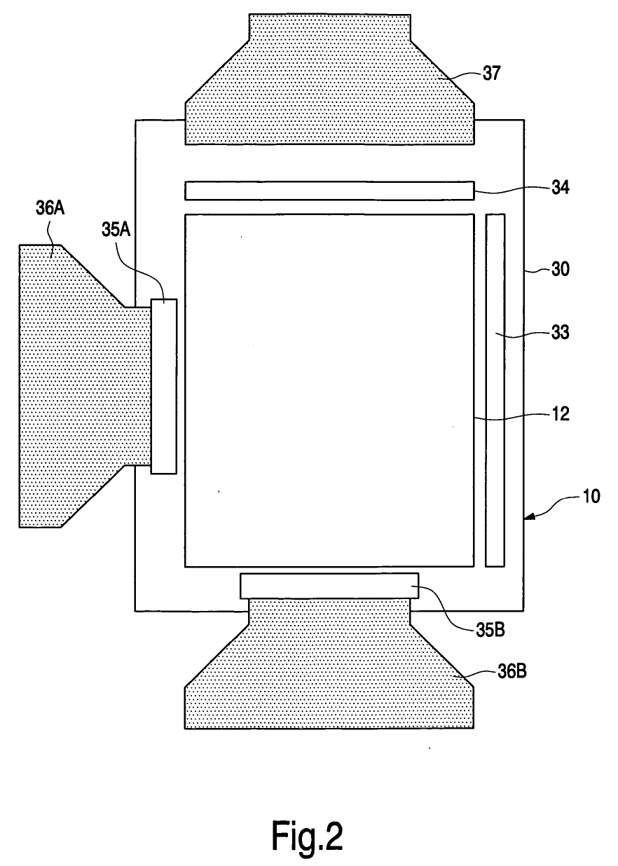

FIG. 2 shows schematically the active substrate of the flat display panel of the device of FIG. 1;

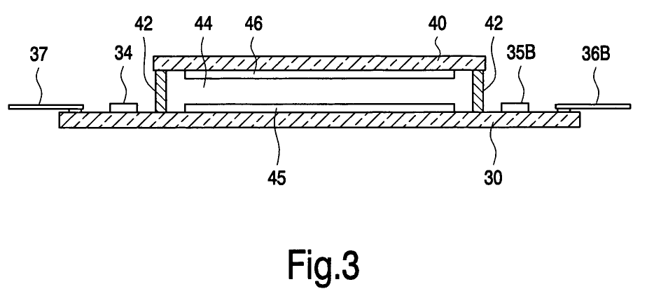

FIG. 3 is a schematic sectional view through the display panel; and

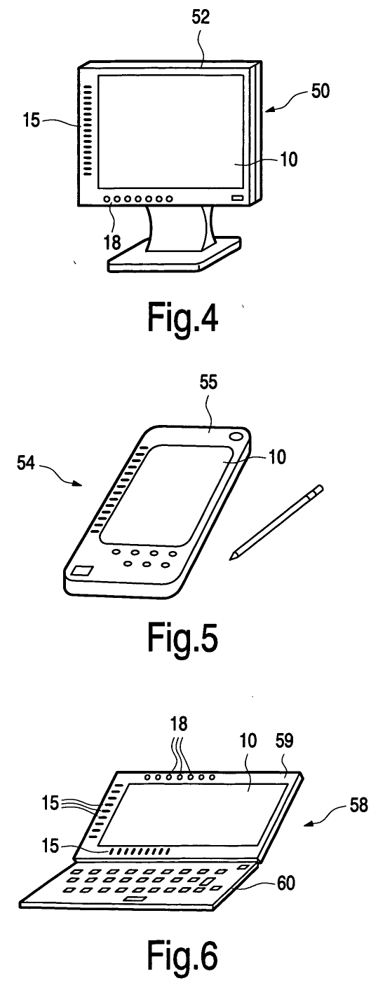

FIGS. 4 to 6 illustrate example electronic devices using the invention.

It will be appreciated that the figures are merely schematic and are not drawn to scale.

Referring to FIG. 1, the electronic device comprises a flat display panel 10 having a display area 12 providing a display output and defined by pixels comprising display elements arranged in a row and column array. The display panel in this embodiment comprises an active matrix liquid crystal display panel of generally conventional constructional form.

As will be described in greater detail hereinafter, the display panel 10 has integrated therein user touch input sensing circuitry. This circuitry is connected with touch elements, in the form of buttons, pads or the like suitably shaped and sized to facilitate touching by a user either with a finger or a stylus and comprising touch sensing electrodes positioned off the display panel. The sensing circuitry is responsive to actuation by a user of the touch elements to perform a touch input function. Two sets of touch elements are provided in the example embodiment of FIGS. 1 and 2, a first set comprising twenty eight touch pads 15 arranged aligned in a column to one side of the display panel 10 and a second set comprising seven comparatively larger touch buttons 18 arranged in a row extending parallel to an adjacent side of the display panel. The touch pads 15 of the first set and the touch buttons of the second set are connected via respective sets of electrical leads 16 and 19 to the touch sensing circuitry integrated in the display panel 10.

The sets of touch elements 15 and 18 are mounted away from the display panel 10 in, or on, a housing or casing 20 of the device containing the display panel 10. The device may, for example, be a computer monitor, PDA (Personal Digital Assistant), electronic book, portable computer system, electronic notebook, a mobile communication device or other such like electronic equipment having a display panel mounted. An AMLCD computer monitor, for example, conventionally has a plastics casing containing the AMLCD panel whose front face bordering the display area of the panel is provided with user-operable control buttons. In such a product, the sets of touch elements 15 and 18 may similarly be arranged on the front face of the casing so as to extend along two sides of the display area of the display panel, while being physically separate therefrom, and either supplementing or replacing at least some of the usual control buttons, as will be described more fully later.

It is common now for the display panel intended for such a product to be supplied to the manufacturer as a module. This usually consists of the display panel carried in a frame to simplify the assembly of the panel component into the product concerned, and possibly including, for example, a backlight (in the case of a transmissive LCD panel) and a connector arrangement enabling simple interconnection with external circuitry. The touch elements may then instead be incorporated in the display module, effectively mounted to the frame but still separated from the display panel itself, with the housing or casing of the product then being designed appropriately to allow a user to touch the control elements in the finished assembly, for example by providing windows in the front face of the housing overlying the two arrays of touch elements on the display panel module.

The touch sensing technology employed in this embodiment is based on a capacitive sensing technique whereby a change in capacitance is caused by a user touching a touch element, this change in capacitance being detected by the touch sensing circuitry integrated in the display panel. Such capacitive sensing techniques are well known. This technology can also be used to allow proximity sensing whereby the presence of a user's finger close to, but not necessarily physically touching, the touch element can be detected instead. Alternatively, a resistor touch input sensing technique also known in the art of touch input sensing may be utilised, wherein, for example, each of the touch elements is sub-divided into two, electrically separate, conductive pads which are sized and shaped so as to be bridged by a user's finger upon touching such that the user's finger provides a resistive electrical path between the conductive pads. The touch elements may instead comprise pressure-sensitive resistive material whose electrical resistance changes in response to touch pressure, or piezoelectric material which generates a voltage in response to touching pressure. Optical sensing techniques could be employed. In this case, the connections 19 and 16 may be replaced by optical fibres leading to photosensors in the sensing circuitry integrated in the display panel with the pads and buttons 15 and 18 consisting of optical components which allow a light path to be interrupted upon touching.

The AMLCD panel 10 is of generally conventional form, and, as is well known, such panels normally comprise a pair of spaced insulating substrates, typically of glass although only one need be transparent, between which liquid crystal material is disposed. One substrate, commonly referred to as the active substrate, carries pixel electrodes arranged in rows and columns and connected to respective switching devices, normally in the form of thin film transistors (TFTs), and sets of row and column address conductors for addressing the pixels with selection and data signals respectively. The other substrate, commonly referred to as the passive substrate, carries an electrode common to all pixels and overlying the array of pixel electrodes on the active substrate. Typically, this substrate also carries an array of colour filter elements for colouring the outputs of the individual pixels to provide a colour display. Each pixel electrode together with an overlying portion of the common electrode and the LC material therebetween defines a light modulating pixel and the array of pixels provides the display area 12. The circuit configuration of a typical pixel is shown greatly enlarged in FIG. 1. The gate and source of the TFT, 25, are connected to respective ones of sets of row address lines 22 and column address lines 24. The drain of the TFT is connected to the pixel electrode, 26. The common electrode is denoted at 28. In operation, the pixel array is driven by row and column driver circuits connected to the sets of row and column address conductors. The row driver circuit selects each row of pixels in turn to turn on the associated TFT's while the column driver circuit supplies data signals to each of the pixels in the selected row that determine the individual display outputs of these pixels. The constructional and operational aspects of such a display device are well known and will not be described here in detail.

With the use, for example, of LTPS (Low Temperature Poly-Silicon) technology to provide the TFTs on the active substrate, it is possible for the row and column drive circuits also to be formed on the active substrate at the periphery of the pixel array. These circuits similarly comprise thin film circuit elements including TFTs, capacitors and connection lines fabricated in the same manner as the components of the active matrix circuit, comprising the pixel TFTs and sets of address conductors, and conveniently at the same time as the active matrix circuit using common deposited layers of conducting, insulating and semiconducting materials and appropriate patterning of these layers, for example by photolithographic etching processes, to build the circuit components. The integration of the drive circuits on the substrate in this way has a number of advantages, including the reduction manufacturing costs by eliminating the need to connect separately fabricated drive circuits to the active matrix circuit and enabling more compact display devices to be produced.

The active substrate of the display panel 10 is provided with integrated drive circuits, in this manner. A schematic plan view of the active substrate is shown in FIG. 2. Referring to FIG. 2, the active substrate, indicated at 30, carries centrally the active matrix circuit, comprising the pixel TFTs and the sets of address conductors, and the array of pixel electrodes which together define the pixel array display area 12. Row and column drive circuits 33 and 34 are fabricated on the substrate 30 at a peripheral regions, along two adjacent sides of the pixel array with the outputs from these circuits being connected to respective ones of the sets of row and column address conductors (not shown).

Also provided on this active substrate 30 is the touch sensing circuitry associated with the touch pads 15 and buttons 18. Conveniently, this circuitry is fabricated in the same manner, and at the same time as, the row and column driver circuits and the active matrix circuit from the same deposited layers, and thus fully integrated on the substrate 30. As such, the sensing circuitry is provided at practically no additional cost.

The touch sensing circuitry is provided in first and second circuits 35A and 35B for the pads 15 and buttons 18 respectively and arranged on peripheral regions of the substrate outside the display area 12 at sides corresponding to the pads and buttons.

Interconnections between the circuits 35A and 35B and the sets of pads 15 and buttons 18 respectively are provided by foils 36A and 36B, comprising flexible polymer material carrying conductive tracks. At their ends proximate the circuits 35A and 35B the foils are bonded to the substrate 30, for example using anisotropic conducting adhesive, with their conductive tracks electrically connecting with respective conductive lines carried on the substrate leading to the sensing circuits. Such foils are commonly used in the field of flat panel display devices. At their ends remote from the substrate 30, the foils are connected to the sensing electrodes constituting the pads and buttons. These electrodes may be mounted directly on the foils for simplicity, or, alternatively, may be carried on separate supports with the foils being connected to those supports.

As shown in FIG. 2, a further foil 37 is connected to the substrate 30 whose purpose is to allow signals to be carried to and from external circuits. For example, thus further foil may be used to carry an externally generated video signal and drive voltages to the display panel or to carry signals indicative of certain touch inputs via the pads or buttons to other circuits, for example a main processor board.

A schematic, highly simplified, sectional view through the panel along a vertical line in the view of FIG. 2 is shown in FIG. 3. As can be seen, the panel includes a second, passive, substrate 40, arranged over the area of the pixel array 12 on the active substrate 30 and sealed, at 42, to the active substrate 30 around its periphery to contain liquid crystal material 44 between the two substrates. The array of pixel electrodes 26 and the associated active matrix circuitry comprising the TFTs 25 and sets of address lines 22 and 24 carried on the substrate 30 are represented here by the block 45. The opposing common electrode 28 and colour filter structure carried on the passive substrate 40 are represented by the block 46. Similarly, the sensing circuitry 35B as the column drive circuit 34 are shown in block form for simplicity. One or more of the circuits 34, 33, 35A and 35B could instead be situated inside, rather than outside, the LC cell defined by the substrates 30 and 40 and the seal 42.

Although separate foils 36A and 36B are used here for the sensing functions, some or all of the signal connections between the touch elements and the sensing circuitry on the substrate could be made instead using the same foil, i.e. foil 37, that carries the drive signals for the display.

An alternative to the use of foils for acting as the signal paths between the substrate 30 carrying the sensing circuits 35A and 35B and the sensing electrodes 15, 18 would be to use paths of conducting plastics, rubber, or other material carried on the structure of the device's casing 20 or the frame of the display panel module. The components may then be arranged such that upon mounting of the display panel or module in the casing or the display panel into the module frame the conducting material either contacts or comes into close proximity to the conducting tracks on the display panel substrate 30 and forms a direct connection or capacitive link to the sensing circuits.

The touch sensing circuits 35A and 35B themselves may be of any known design, depending on the nature of the touch sensing technique utilised, e.g. capacitive or resistive. Such circuits are operable to supply signals to the pad and button electrodes and responsive to the effects of touching thereof to provide output signals indicative of the touching of individual touch elements. The output signals may be used either by the circuitry carried on the substrate 30 or by external circuitry (via the foil 37) according to the function associated with the elements concerned. As examples, for capacitive sensing, the circuits may comprise charge sensing circuits for measuring charge on the touch electrodes or oscillator circuits whose frequency is dependent on the capacitance of the touch elements. For resistive sensing, potential divider circuits may be used.

In handheld and mobile devices incorporating display panels, where it is generally not possible to use a conventional keyboard, touch input and interactivity have been used for various purposes. Typical examples of such relating to a possible computer device and described in U.S. Pat. No. 5,900,875.

In the embodiment of FIG. 1, the linear array of touch buttons 18 can be configured as soft (programmable) keys, the outputs of the sensing circuitry being appropriately used by the device to this end. They may instead be arranged to form a simple keypad, a matrix or other set of soft keys.

The set of touch pads 15 are here utilised in a novel way to perform a scroll bar function. With, for example, the device incorporating the display panel operating with a software application providing scroll bar functions, then through a user moving his finger upwardly and downwardly over the linear array of touch pads 15, information on the display associated with a scroll bar type function can be scrolled up or down in much the same way as a scroll wheel on a mouse operates. By touching an individual pad 15 along the array, the displayed information is instantly scrolled to the corresponding position, rather like clicking and dragging the scroll button in a scroll bar.

An advantage of the described arrangement is that the touch elements constituting the pads 15 and buttons 18 can easily be made of different sizes, shapes, and arranged in different configurations as appropriate for their respective functions, without the need to modify the layout of the tracks or circuitry integrated on the active substrate of the display panel. Although the device of FIGS. 1 and 2 uses two separate sets of control elements arranged adjacent two sides of the display panel, it will be appreciated that further sets or other configurations are readily possible.

The integration of the sensing circuitry 35A and 35B on the active substrate 30 is particularly advantageous when the function or functions performed by the touch input facility is used in conjunction with another circuit function carried out by circuitry similarly integrated on the substrate. In these circumstances the need to provide additional external ICs can be avoided. For example, in the case where memory is integrated on the active substrate 30, again using thin film technology, and used to store display data, the outputs of the sensing circuitry could be used in conjunction with this memory to enable scrolling through the stored data. With this function being achieved solely by circuitry integrated on the active substrate, the need to transfer signals to external circuits is removed. As further examples of this advantageous capability, the touch input sensing circuitry can be used to control drive parameters of the display panel such as the voltages determining the display's contrast or brightness.

As mentioned, a number of different sensing techniques could be used, with the preferred examples being capacitive and resistive techniques. Some techniques would require the use of analogue circuitry within the sense circuits. This is more easily achievable using the integrated approach than using conventional ICs. By integrating this circuitry on the active substrate, external mixed signal ICs are unnecessary.

While a device embodiment described above employs an AMLCD, it will be appreciated that other kinds of flat display panels could be used, such as electrophoretic, electrochromic, and electroluminescent display panels. In some cases, for example, active matrix organic LED display panels using polymer or organic light-emitting materials (AMPLEDs and AMOLEDS), then only one substrate would normally be used to carry the active matrix circuit and the display material.

Examples of different electronic devices to which the invention can be applied are illustrated schematically in FIGS. 4 to 6. FIG. 4 shows a computer monitor 50 in which a display module incorporating the display panel 10 is mounted in a housing 52, with the arrays of touch pads 15 and touch buttons 18 arranged on the housing along adjacent sides of the display panel. Here the pads 15 may be used for display scrolling and the buttons 18 for controlling display parameters. In a similar kind of product intended for TV display, the pads 15 may be organised in groups and used to control respective parameters such as brightness, colour, contrast etc.

FIG. 5 shows a PDA type device 54 comprising a display panel 10 mounted in a casing 55 in which the pads 15 are used for scrolling through information displayed on the display panel 10 and the buttons 18 are configured as soft keys.

FIG. 6 illustrates a notebook computer 58 in which a display panel 10 is mounted in one housing part 59 and a keypad is provided in another housing part 60. In this example, two arrays of touch pads 15 are arranged adjacent two side of the display area, for example for facilitating scrolling in two dimensions which touch buttons 18 configured on soft keys are arranged along an upper edge of the display panel.

Although the invention is particularly beneficial when using active matrix display panels having integrated, thin film, drive circuits, it is envisaged that the invention could be applied to advantage also to devices using display panels in which the drive circuits are not integrated on one substrate of the panel but instead are provided in the form of ICs mounted on the substrate using, for example, a chip on glass technique. In this case, the touch sensing circuitry, corresponding to circuits 35A and 35B, could be implemented as separate ICs mounted on the substrate or instead be integrated within the drive ICs.

From reading the present disclosure, other modifications will be apparent to persons skilled in the art. Such modifications may involve other features which are already known in the field of flat display panels with touch input sensing and component parts therefor and which may be used instead of or in addition to features already described herein.

1. An electronic device comprising a display panel having at least one substrate on which are formed display pixels defining a display area in which information is displayed, the device further including a drive circuit for driving the pixels, and touch input means operable by a user to perform input functions, the touch input means comprising a plurality of touch elements which are spaced from the substrate of the display panel and a sensing circuit connected to the touch elements for sensing touching of the touch elements by a user, wherein the drive circuit for the pixels and the sensing circuit of the touch input means are both carried on the substrate of the display panel.

2. An electronic device according to claim 1, wherein the pixel drive circuit and the sensing circuit comprise thin film circuits integrated on the substrate of the display panel.

3. An electronic device according to claim 1, wherein the electronic device includes a housing that surrounds the display area of the display panel, and the touch elements are located in the housing.

4. An electronic device according to claim 1, wherein the display panel forms part of a display module which includes a frame in which the display panel is carried, and wherein the touch elements are mounted to the frame of the display module.

5. An electronic device according to claim 1, wherein the sensing circuit is responsive to a change in capacitance at a touch element due to a user touching the touch element.

6. An electronic device according to claim 1, wherein the sensing circuit is responsive to a change in resistance at a touch element resulting from a user touching the touch element.

7. An electronic device according to claim 1, wherein at least one output of the sensing circuit is used to control a display parameter.

8. An electronic device according to claim 1, wherein the touch elements are arranged in one or more arrays extending adjacent one or more sides of the display panel.

9. An electronic device according to claim 1, wherein the sensing circuit is responsive to touching of touch elements to control scrolling of information displayed in the display area.

10. An electronic device according to claim 1 wherein the display panel comprises an active matrix display panel.
